(19) United States
(12) Patent Application Publication
(10) Pub. No.: US 2016/0132834 A1
(43) Pub. Date: May 12, 2016

(54) PERSONALIZED JOB SEARCH

(71) Applicants: Kumaresh Pattabiraman, Sunnyvale, CA (US); Ganesh Venkataraman, San Jose, CA (US); Shakti Dhirendraji Sinha, Sunnyvale, CA (US)

(72) Inventors: Kumaresh Pattabiraman, Sunnyvale, CA (US); Ganesh Venkataraman, San Jose, CA (US); Shakti Dhirendraji Sinha, Sunnyvale, CA (US)

(21) Appl. No.: 14/863,188

(22) Filed: Sep. 23, 2015

Related U.S. Application Data
(60) Provisional application No. 62/076,965, filed on Nov. 7, 2014.

(51) Int. Cl. G06Q 10/10; G06F 17/30

(52) U.S. Cl. CPC G06Q 10/1053; G06F 17/30864

(57) ABSTRACT

Techniques for assisting a user in conducting an online job search for online job listings are described. According to various embodiments, a user specification of a job search query including at least one user-specified job search query term is received. Values for one or more member profile attributes of the user are then accessed. Thereafter, the job search query is modified based on the accessed values for the member profile attributes of the user, the modifying comprising inserting job search query terms corresponding to the values for the member profile attributes into the job search query. Search results corresponding to job listings posted on the job search engine are then generated, based on the modified job search query. Further, one or more of the search results may be displayed, via a user interface.

### CROSS-REFERENCE TO RELATED APPLICATIONS

This application claims the priority benefit of U.S. Provisional Application No. 62/076,965, filed Nov. 7, 2014, which is incorporated herein by reference.

### TECHNICAL FIELD

The present application relates generally to data processing systems and, in one specific example, to techniques for assisting a user in conducting an online job search for online job listings.

### BACKGROUND

Online social network services such as LinkedIn® are becoming increasingly popular, with many such websites boasting millions of active members. Each member of the online social network service is able to upload an editable member profile page to the online social network service. Further, online social network services such as LinkedIn® include a search feature where, for example, a member may search for other member profile pages, company profile pages, jobs, etc., posted on the online social network service.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a flowchart illustrating an example method, according to various embodiments;

FIG. 4 is a flowchart illustrating an example method, according to various embodiments;

FIG. 5 is a flowchart illustrating an example method, according to various embodiments;

FIG. 6 is a flowchart illustrating an example method, according to various embodiments;

FIG. 7 illustrates an example mobile device, according to various embodiments; and

FIG. 8 is a diagrammatic representation of a machine in the example form of a computer system within which a set of instructions, for causing the machine to perform any one or more of the methodologies discussed herein, may be executed.

### DETAILED DESCRIPTION

Example methods and systems for assisting a user in conducting an online job search for online job listings are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various example embodiments, a personalized job search system is configured to aid a user in conducting searches, such as searches for job listings on an online social network service such as LinkedIn®. For example, the LinkedIn® online social network service includes a job search user interface in conjunction with a job search engine, whereby a user can enter search terms such as “architect”, and click on a “Search” button in order to view search results of job listings matching the search query terms. Since the LinkedIn® online social network service has millions of job listings, a significant number of results may be returned for a given job query search.

In some embodiments, the personalized job search system filters a large result set to display results that are most likely to matter to a job searcher on a personalized basis. For example, suppose a job searcher searches for “architect”, and the result set includes 10,000 results for that query. Thus, if all these results are provided to the searcher, the searcher may be become overwhelmed with jobs that have nothing to do with who they are as a job seeker. Accordingly, the personalized job search system 200 may utilize member profile attributes of the searcher to adjust search results. For example, if the searcher submits a query for “architect” jobs, and the searcher's Skills, industry, title, etc., indicate that they are a traditional architect rather than a software architect, then the personalized job search system will help to display search results for those traditional architect jobs, as opposed to “software architect” jobs, etc., based on the techniques described herein. Accordingly, by improving the relevance of search results, the system described herein efficiently provides searchers with more relevant results sooner, which reduces the need for further searching and browsing on the part of the searcher. This may result in a reduction in the processing power and network bandwidth demands placed on search engine hardware and software infrastructure.

Thus, the personalized job search system described herein factors in various member profile attributes of the searching member, such as current title, past title, skills, industry, location, job function, seniority, etc., to boost or highlight job search results that have a similar titles, skills, industries, locations, and so on. For example, the personalized job search system 200 may filter the search results (e.g., online job postings or listings) to display only those that are associated with job titles that match current or past titles included in the member profile data of the searcher, or only those that list required/desired Skills that match skills included in the member profile data of the searcher, or only those that are associated with an industry that matches an industry listed in the member profile data of the searcher, and so on. Instead of filtering job search results to display only certain results matching member profile attributes of the searcher (as described above), the personalized job search system 200 may rank the search results, so that the results matching the member profile attributes of the searcher are displayed higher than other results not matching the member profile attributes of the searcher.

Non-limiting examples of member profile attributes include name, username, social media handle, email address, geographic address, networks, location, phone number, fax number, groups, member connections, connection count, past or present education information, past or present employment information, past or present volunteer information, resume information, skills, endorsements, recommendations, title, industry, company size, seniority level, activities, group membership, images, photos, preferences, news, status, links or URLs on a profile page, and so forth.

In some embodiments, the personalized job search system may display a user interface enabling an operator of the personalized job search system website personnel and/or administrators) to adjust the filtering criteria for filtering search results. For example, the user interface may allow the operator to specify one or more member profile attributes that should be utilized as the basis for filtering search results. The user interface may also enable the operator to specify priorities associated with each of the selected member profile attributes, in order to specify how important each of the member profile attributes are, for the purposes of filtering search results. For example, the operator may specify that a job title match is the highest (priority/most important of the filtering criteria, whereas industry represents the second highest priority/second most important of the filtering criteria. Thus, all job search results with matching job titles will be displayed before/higher than all job search results without matching job titles. Further, among the job search results with matching job titles, those job search results with matching industry will be displayed before/higher than those job search results without matching industry. The techniques described herein may be beneficial when applied to “empty searches” or “empty keyword searches”, where a search is performed without any specified search query terms. This may occur when a user lands on a page of search results by clicking on a link on an external webpage, such as a Company page webpage associated with the LinkedIn® online social network service. For example, suppose a user visits a Company page for XYZ Corporation hosted by the LinkedIn® online social network service, and the user clicks on a link “see jobs at XYZ Corporation”, after which they land on a page of search results showing jobs at XYZ Corporation. Such search results would constitute empty keyword search results, since no keywords such as “product manager” or “architect” have yet been specified by the user. Accordingly, the personalized job search system may refine the search results of such a search based on the member profile attributes of the searching member. Thus, when the searching member arrives at the search results page, the search results are already personalized based on their member profile attributes, consistent with various embodiments described herein.

The techniques described herein may also be beneficial when applied to “empty searches” or “empty keyword searches” with a location selected. For example, the LinkedIn® online social network service includes a job search user interface in conjunction with a job search engine, where the job search user interface includes a query user interface element (commonly referred to as a “search bar”) where the user can enter search query terms such as “architect”, and click on a “Search” button in order to view search results of job listings matching the search query terms. In addition to the query user interface element, the job search user interface element may include various user-selectable filtering elements that can further filter the search results (e.g., based on the search performed on the search query terms in the query user interface element). For example, the filtering elements may include a number of radio buttons, check boxes, or links associated with different values of an attribute, such as a location attribute (e.g., different locations such as “Seattle”, “San Francisco Bay Area”, etc.). Thus, it is possible that the user may select one of the filtering elements for a location, such as by selecting a radio button, check box, or link associated with “San Francisco Bay Area”, and then click on the “Search” button without entering any search query terms in the query user interface element. In this case, the search engine will perform an “empty search” or “empty keyword search” with a location selected (e.g., since the user may desire or intend to see all jobs in the San Francisco Bay Area). In this case, the techniques described herein may help provide personalized relevant results to the user. For example, the personalized job search system described herein may factor in various member profile attributes of the searching member, such as current title, past title, skills, industry, job function, seniority, etc., to boost or highlight job search results (for the selected location) that have a similar titles, skills, industries, and so on, consistent with various embodiments described herein.

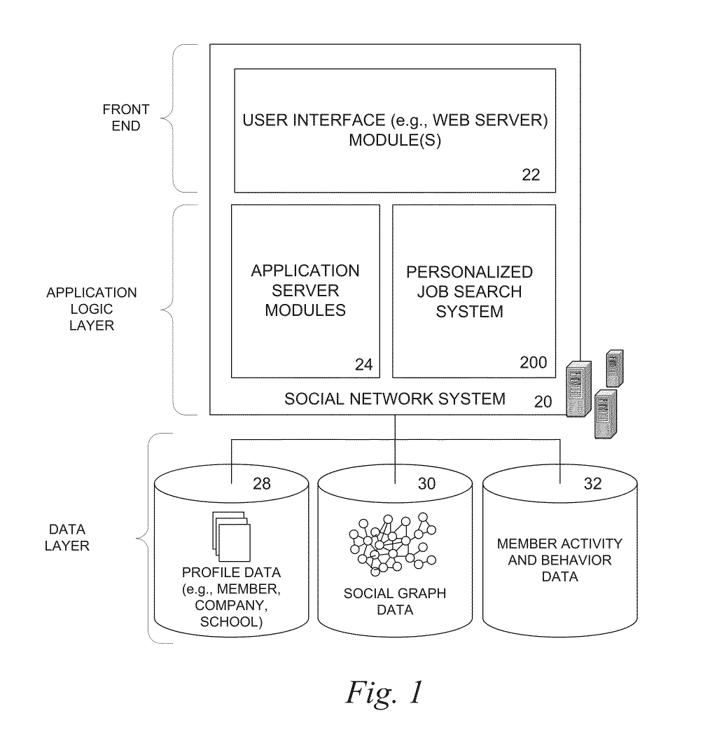

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

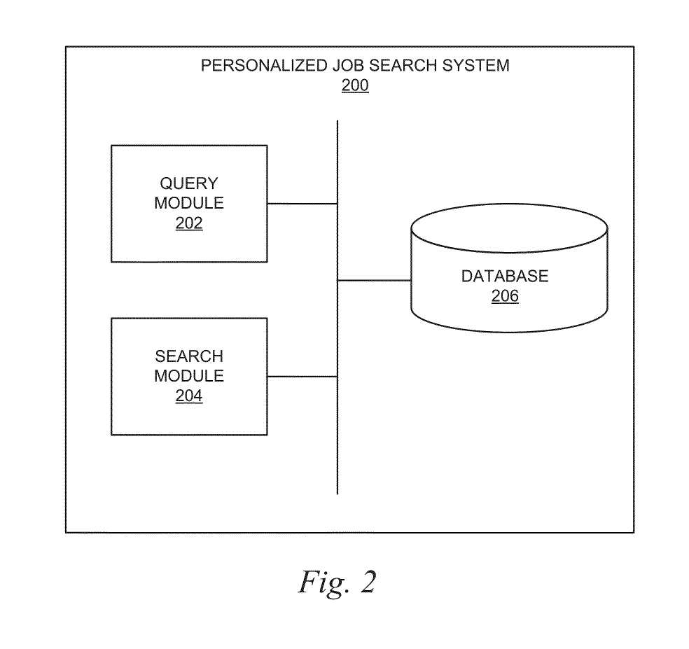

With some embodiments, the social network system 20 includes what is generally real-red to herein as a personalized job search system 200. The personalized job search system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, a personalized job search system 200 includes a query module 202, a search module 204, and a database 206. The modules of the personalized job search system 200 may be implemented on or executed by a single device such as a personalized job search device, or on separate devices interconnected via a network. The aforementioned personalized job search device may be, for example, one or more client machines or application servers. The operation of each of the aforementioned modules of the personalized job search system 200 will now be described in greater detail in conjunction with the various figures.

The query module 202 may be configured to receive an initial job search query in the form of one or more clauses, with each clause comprising a corresponding search operator and search term (or operand). A search operator is a language construct that can behave like a function for a search query and narrow the search results of the search query. Search operators can comprise functional words or signs that instruct, or otherwise indicate to, a search engine such as the search module 204, how to connect or separate the given search terms. Boolean operators, such as AND, OR, and NOT are examples of search operators. In some embodiments, the search operators comprise a “required” operator that indicates that the search module 204 should only include, in the search results, records that contain the term to which the required operator is being applied, an “optional” operator that indicates that the search module 204 should attempt to include, in the search results, records that contain the term to which the optional operator is being applied without requiring that the term be present in the search results, and an “exclusion” operator that indicates that the search module 204 should exclude, from the search results, any records that contain the term to which the exclusion operator is being applied. These indications to treat the search terms as required, optional, or excluded can cause an initial search query to include corresponding search operators. In some embodiments, the symbol ‘+’ is used as the required operator, the symbol ‘?’ is used as the optional operator, and the symbol ‘−’ is used as the exclusion operator. It is contemplated that other symbols, characters, or terms can be used as the search operators.

The operation of the query module 202 and the search module 204 will now be described in more detail in conjunction with a non-limiting example use case. Suppose a member A and a member B of an online social networking service such as LinkedIn® submit a job search query “ACME” (with only a single search query term “ACME” corresponding to a company name). At the company ACME, there may be many job types (e.g., product manager, software engineer, sales, marketing, legal, etc.), and the online social network service may have several job listing for the company ACME for each of these job types. Thus, the personalized job search system 200 will personalize the search results for this query for the searcher, based on the member profile attributes of the searcher (e.g., job title, skills, industry, job function, location, etc.).

For example, suppose member A is software engineer (as identified by the job title in their member profile data), while person B is a product manager. The query module 202 may begin to formulate a modified search query that specifies the original user-specified search query term “ACME” and various member profile attributes of the searcher. For example, for member A having the job title “software engineer”, the modified search query generated by the query module 202 may correspond to “+ACME+software+engineer” (or “+ACME+“software engineer””), where the required operator “+” is applied to each of the search query terms “ACME”, “software”, and “engineer” (or “ACME” and “software engineer”). Thus, the search module 204 may search a database (e.g., database 206) for any job listings where the terms “ACME”, “software”, and “engineer” (or “ACME” and “software engineer”) are present in the job listing (e.g., anywhere in the job listing). Alternatively, the modified search query generated by the query module 202 may correspond to “+ACME?software?engineer” (or “+ACME?“software engineer””), where the required operator “+” is applied to the original user-specified search query term “ACME”, and the optional operator “?” is applied to the terms “software” and “engineer” (or “software engineer”) inserted by the query module 202. Thus, the search module 204 may search a database (e.g., database 206) for any job listings where the term “ACME” is present, and the terms “software” and “engineer” (or “software engineer”) are optionally present (e.g., anywhere in the job listing). Likewise, for member B having the job title “product manager”, the modified search query generated by the query module 202 may correspond to “+ACME+product+manager”, or “+ACME+“product manager””, or “+ACME?product?manager”, or “+ACME?“product manager””, etc., as described above. Thus, when person A searches for “ACME” via the online social networking service, they are presented with software manager jobs, and when user B also searches for “ACME” via the online social networking service, they receive product manager jobs. This may be especially advantageous in the case of “empty searches” based on clicking a jobs link on a particular company page, as described elsewhere herein.

While the examples above discuss the member profile attribute of ob title, it is understood that other member profile attributes may be applied to the techniques described herein. For example, the query module 202 may insert the skills, industry, job function, company size, seniority level, etc., associated with the member into the modified search query.

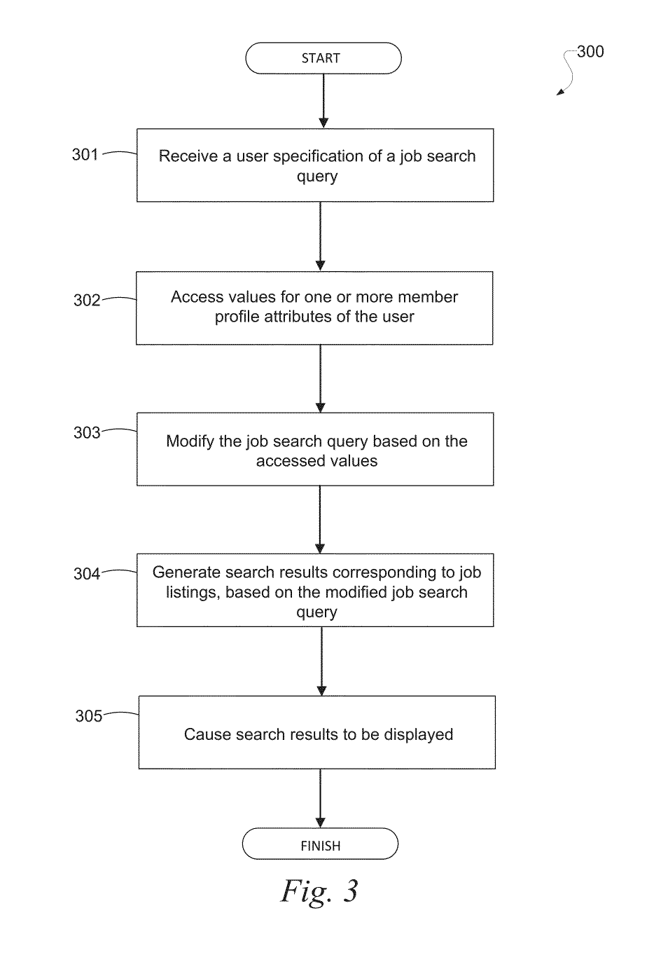

FIG. 3 is a flowchart illustrating an example method 300, consistent with various embodiments described herein. The method 300 may be performed at least in part by, for example, the personalized job search system 200 illustrated in FIG. 2 (or an apparatus having similar modules, such as one or more client machines or application servers). In operation 301, the query module 202 receives, via a user interface of a job search engine, a user specification of a job search query including at least one user-specified job search query term. In operation 302, the query module 202 accesses, from a database associated with an online social networking service (e.g., database 206 in FIG. 2), values for one or more member profile attributes of the user that specified the job search query in operation 301. Non-limiting examples of member profile attributes include job title, location, industry, skills, and seniority level. In operation 303, the query module 202 modifies the job search query specified in operation 301, based on the values for the member profile attributes of the user that were accessed in operation 302. For example, the query module 202 may insert job search query terms corresponding to the values for the member profile attributes into the job search query. In operation 304, the search module 204 generates search results corresponding to job listings posted on the job search engine, based on the modified job search query that was modified in operation 303. In some embodiments, the search module 204 may associate a required search operator with all of the terms in the modified job search query (including the user-specified job search query term and the inserted job search query terms). Alternatively, the search module 204 may associate a required search operator with the user-specified job search query term and an optional search operator with each of the inserted job search query terms. In operation 305, the search module 204 causes one or more of the search results generated in operation 304 to be displayed, via a user interface. It is contemplated that the operations of method 300 may incorporate any of the other features disclosed herein. Various operations in the method 300 may be omitted or rearranged, as necessary.

In some embodiments, each of the job listings posted on the online social networking service and/or accessible via a job search engine may be associated with one or more job listing electronic data fields, including company, job title, location, industry, skills, and job description. For example, a data entry/record associated with each job listing may be stored in a database (e.g., database 206 in FIG. 2), where each data entry/record may include multiple data fields containing data such as company, job title, location, industry, skills, job description, etc.

Accordingly, before the search module 204 searches for job listings matching job query terms, the query module 202 may ensure that the appropriate data fields for each possible job record are searched for the corresponding type of member profile attribute inserted into the job query. For example, for member A described above having the job title of “software engineer” that specifies the search query “ACME”, the search module 204 may first identify that the search query “ACME” corresponds to an entity such as a company, using any known techniques for determine that a search query term matches a particular entity. For example, the query module 202 may compare the search query term “ACME” against a list of known companies, and determine that there is a match between the search query term and the title of a known company “ACME”. Once it is determined that the search query term corresponds to a company, the query module 202 may begin to formulate a modified search query that specifies “ACME” as a company data field “software engineer” as being associated with the job title data field. An example of such a query is “+c:ACME+t:“software engineer””, where “+c:” specifies a company job listing data field and “+t:” specifies a job title data field. Thus, the search module 204 may search a database (e.g., database 206) for any job listings associated with or posted by the company “ACME”, and where the terms “software engineer” are present in the appropriate job listing data field (e.g., job title) of the job listings. The personalized job search system may perform a similar technique when the user-specified term corresponds to another type of job listing data field (e.g., when the user simply specifies a job title, a location, an industry, a skill, etc.).

Thus, according to various example embodiments, the search module 204 may determine that a user-specified job search query term (e.g., “ACME”) corresponds to a value of a particular job listing data field (e.g., a company) of plural job listings. Thus, the search module 204 may insert a search field limitation operator (e.g., a company search field limitation operator) into the job search query in association with the user-specified job search query term, where the search field limitation operator specifies the corresponding job listing data field (e.g., a company data field) of job listings that is to be searched for the user-specified job search query term (e.g., “ACME”).

Further, according to various example embodiments, the search module 204 may insert a search field limitation operator (e.g., a job title field limitation operator) into a job search query in association with each of job search query terms (e.g., “software engineer”) inserted by the query module 202, each of the search field limitation operators specifying that a particular job listing data field of plural job listings is to be searched for the corresponding inserted job search query term. For example, each of the search field limitation operators may specify the particular job listing data field (e.g., job title) that is related to the member profile attribute (e.g., job title) that served as the basis for the inserted job search query term (e.g., “software engineer”).

According to various example embodiments, the search module 204 may determine, for each of various candidate job results, a feature value representing how many search query terms are present in that job listing. These feature values may then be used to weight the job search results. For example, job results associated with a higher feature value will be displayed higher or more prominently in the search results.

For example, suppose there are 2 candidates for search results for a job search for “ACME”, the first being Job1 for a software engineer at ACME (e.g., a company field of Job1 is “ACME” and the job title field of Job1 is “software engineer”), and the second being Job2 for product manager at ACME (e.g., a company field of Job2 is “ACME” and the job title field of Job2 is “product manager”). If member A having the job title of “software engineer” submits the job query, the modified query generated by the query module 202 may state “+ACME+software+engineer”. The search module 204 will then determine that 3 query terms (“ACME”, “software”, and “engineer”) match Job1, whereas only 1 query term (“ACME”) matches job2. Thus, Job1 will be assigned a weight value of 3, whereas Job2 will be assigned a weight value of 1. These candidate jobs may then be ranked based on their weight values, with the highest ranked candidate job listing (e.g., Job1) being displayed higher or more prominently to member A. On the other hand, if member B having the job title of “product manager” submits the same job query, the modified query generated by the query module 202 will state “+ACME+product+manager”. The search module 204 will then determine that only 1 query term (“ACME”) matches job1, whereas 3 query terms (“ACME”, “product”, and “manager”) match Job2. Thus, Job1 will be assigned a weight value of 1, whereas Job2 will be assigned a weight value of 3. These candidate jobs may then be ranked based on their weight values, with the highest ranked candidate job listing (e.g., Job2) being displayed higher or more prominently to member B.

In some embodiments, the personalized job search system 200 may help prevent relevant job listings with slightly different job titles from the user's job title (e.g., software engineering vs. software engineer) from being filtered out from the result list. For example, if member A having the job title of “software engineer” submits the job query “ACME”, the modified query generated by the query module 202 may state “+ACME+software+engineer”, as described above. Suppose one of the candidate job results is Job3 for “software engineering” at ACME (e.g., a company field of Job3 is “ACME” and the title field of Job3 is “software engineering”). The search module 204 will then determine that 2 query terms (“ACME” and “software”) match Job3, and Job3 will be assigned a weight value of 2 and will be displayed accordingly. Thus, by using feature values that indicate the number of search query terms that match the job search results, even job search results that do not exactly match search criteria are given a relative amount of weight when being presented to the user.

As described above, it is understood that other member profile attributes may be applied to the techniques described herein. For example, the query module 202 may insert the skills, industry, job function, company size, seniority level, etc., associated with the member into the modified search query, and the search module 204 may modify a feature value associated with each of various candidate job results, based on how many of the query terms are present in the candidate job result.

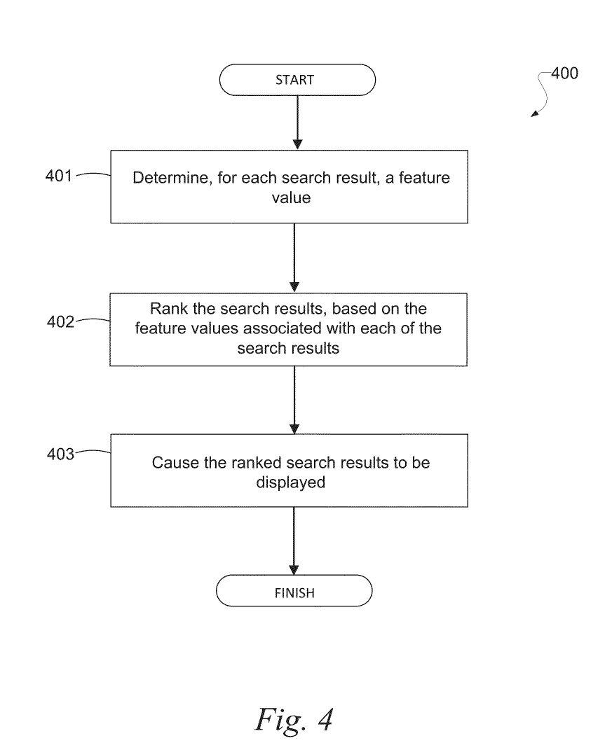

FIG. 4 is a flowchart illustrating an example method 400, consistent with various embodiments described herein. The method 400 may be performed at least in part by, for example, the personalized job search system 200 illustrated in FIG. 2 (or an apparatus having similar modules, such as one or more client machines or application servers). In operation 401, the search module 204 determines, for each search result in a set of search results (e.g., the search results calculated in operation 304 in FIG. 3), a feature value indicating a number of job search query terms in the modified job search query (e.g., as modified in operation 303 in FIG. 3) that are detected in the corresponding search results. In operation 402, the search module 204 ranks the search results, based on the feature values associated with each of the search results calculated in operation 401. In operation 403, the search module 204 causes the search results ranked in operation 402 to be displayed to the user. It is contemplated that the operations of method 400 may incorporate any of the other features disclosed herein. Various operations in the method 400 may be omitted or rearranged, as necessary.

In some embodiments, the personalized job search system 200 may help prevent relevant job listings with slightly different titles from the user's job title (e.g., software engineering vs. software engineer) from being filtered out from the result list, by modifying the search results to show alternative search query terms with respect to the member profile attributes of the searcher. For example, if member A having the job title of “software engineer” submits the job query “ACME”, the system may determine that the search query terms engineer and engineering are related. For example, the query module 202 can access information identifying related terms (e.g., for a given term X, the related terms are Y1, Y2, Y3, etc.). The query module 202 may then modify the search query terms to list all alternative terms (e.g., in the case of member A: “software and (engineer OR engineering)”.

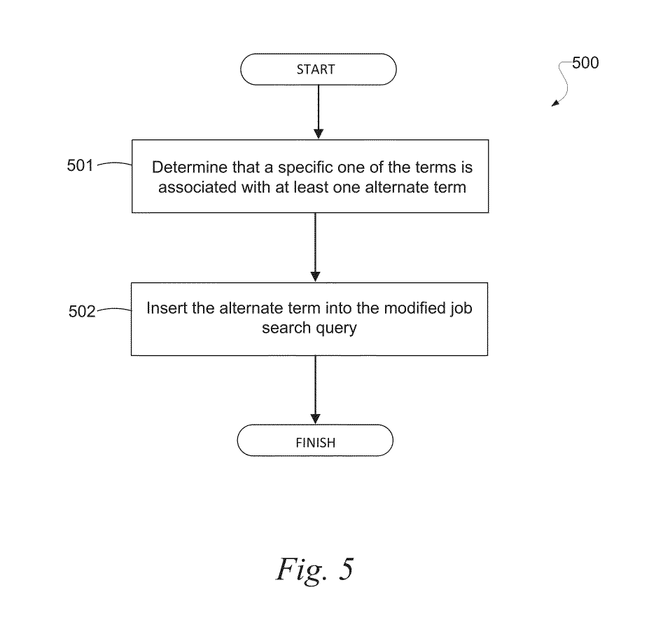

FIG. 5 is a flowchart illustrating an example method 500, consistent with various embodiments described herein. The method 500 may be performed at least in part by, for example, the personalized job search system 200 illustrated in FIG. 2 (or an apparatus having similar modules, such as one or more client machines or application servers). In operation 501, the query module 202 determines that a specific term in a job search query (e.g., as modified in operation 304 in FIG. 3) is associated with at least one alternate term, based on alternate term information (e.g., stored in database 206 in FIG. 2). In operation 502, the query module 202 inserts the alternate term into the modified job search query, and associates the alternate term and the specific term via an OR operator. It is contemplated that the operations of method 500 may incorporate any of the other features disclosed herein. Various operations in the method 500 may be omitted or rearranged, as necessary.

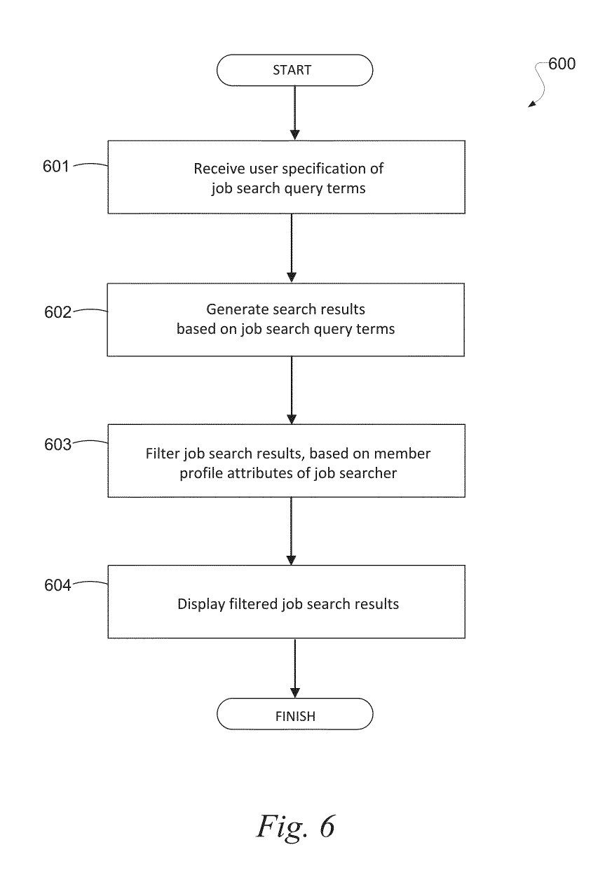

In some embodiments, rather than modifying a job search query before performing a search, the search module 204 may first search for job listings matching the user-specified query term(s), and then the search module 204 may filter the search results based on the member profile attributes of the searcher. For example, FIG. 6 is a flowchart illustrating an example method 600, consistent with various embodiments described above. The method 600 may be performed at least in part by, for example, the personalized job search system 200 illustrated in FIG. 2 (or an apparatus having similar modules, such as one or more client machines or application servers). In operation 601, the query module 202 receives, via a job search user interface, from a searching member of an online social networking service, a user specification of job search query terms. In operation 602, the search module 204 generates a list of job search results, based on the user-specified job search query terms received in operation 601. In operation 603, the search module 204 filters the list of job search results generated in operation 602, based on member profile attributes of the searching member. Such member profile attributes may be stored at, for example, the database 28 illustrated in FIG. 1 and/or the database 206 illustrated in FIG. 2. In operation 604, the filter module 204 displays, via the job search user interface, the filtered list of job search results that were filtered in operator 603. It is contemplated that the operations of method 600 may incorporate any of the other features disclosed herein. Various operations in the method 600 may be omitted or rearranged, as necessary.

### Example Mobile Device

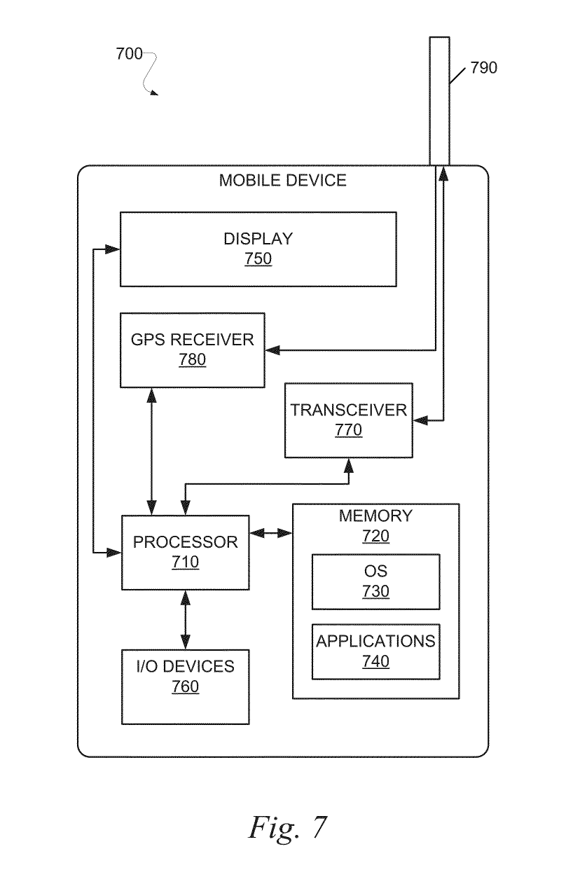

FIG. 7 is a block diagram illustrating the mobile device 700, according to an example embodiment. The mobile device may correspond to, for example, one or more client machines or application servers. One or more of the modules of the system 200 illustrated in FIG. 2 may be implemented on or executed by the mobile device 700. The mobile device 700 may include a processor 710. The processor 710 may be any of a variety of different types of commercially available processors suitable for mobile devices (for example, an XScale architecture microprocessor, a Microprocessor without Interlocked Pipeline Stages (MIPS) architecture processor, or another type of processor). A memory 720, such as a Random Access Memory (RAM), a Flash memory, or other type of memory, is typically accessible to the processor 710. The memory 720 may be adapted to store an operating system (OS) 730, as well as application programs 740, such as a mobile location enabled application that may provide location based services to a user. The processor 710 may be coupled, either directly or via appropriate intermediary hardware, to a display 750 and to one or more input/output (I/O) devices 760, such as a keypad, a touch panel sensor, a microphone, and the like. Similarly, in some embodiments, the processor 710 may be coupled to a transceiver 770 that interfaces with an antenna 790. The transceiver 770 may be configured to both transmit and receive cellular network signals, wireless data signals, or other types of signals via the antenna 790, depending on the nature of the mobile device 700. Further, in some configurations, a GPS receiver 780 may also make use of the antenna 790 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

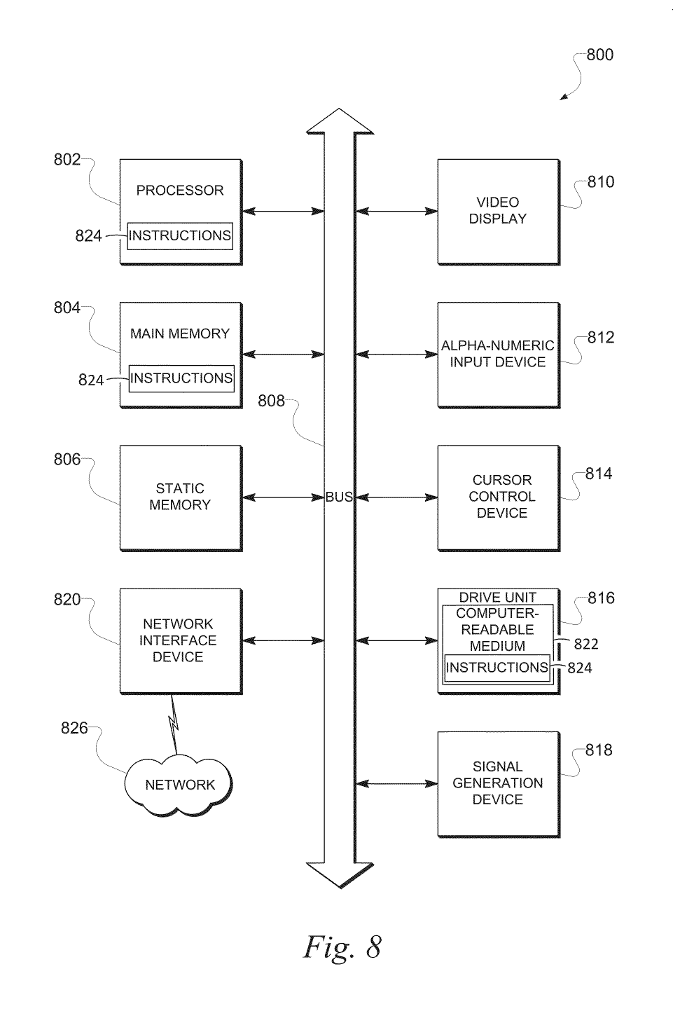

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, via a user interface of a job search engine, a user specification of a job search query including at least one user-specified job search query term;
accessing, from a database associated with an online social networking service, values for one or more member profile attributes of the user;
modifying, using one or more processors, the job search query based on the accessed values for the member profile attributes of the user, the modifying comprising inserting job search query terms corresponding to the values for the member profile attributes into the job search query;
generating search results corresponding to job listings posted on the job search engine, based on the modified job search query; and
causing one or more of the search results to be displayed, via the user interface.

2. The method of claim 1, wherein the one or more member profile attributes include job title, location, industry, skills, and seniority level.

3. The method of claim 1, further comprising associating a required search operator with each of the terms in the modified job search query including the user-specified job search query term and the inserted job search query terms.

4. The method of claim 1, further comprising associating a required search operator with the user-specified job search query term and an optional search operator with each of the inserted job search query terms.

5. The method of claim 1, wherein each of the job listings in the job search engine are associated with one or more job listing data fields, when the data fields include at least one of company, job title, location, industry, skills, and job description.

6. The method of claim 1, wherein the modifying further comprises inserting search field limitation operator into the job search query in association with each of the inserted job search query terms, each of the search field limitation operators specifying that a particular job listing data field of plural job listings is to be searched for the corresponding inserted job search query term.

7. The method of claim 6, wherein each of the search field limitation operators specifies the particular job listing data field that is related to the member profile attribute associated with the corresponding inserted job search query term.

8. The method of claim 1, further comprising determining that the user-specified job search query term corresponds to a value of a particular job listing data field of plural job listings, and
wherein the modifying further comprises inserting a search field limitation operator into the job search query in association with the user-specified job search query term, the search field limitation operator specifying that the particular job listing data field of the plural job listings is to be searched for the user-specified job search query term.

9. The method of claim 1, wherein the particular job listing data field corresponds to a company, a job title, a location, an industry, or a skill.

10. The method of claim 1, further comprising:
determining, for each search result in the search results, a feature value indicating a number of job search query terms in the modified job search query that are detected in the corresponding search result;
ranking the search results, based on the feature values associated with each of the search results; and
causing the ranked search results to be displayed to the user.

11. The method of claim 1, further comprising:
determining that a specific one of the terms in the modified job search query is associated with at least one alternate term, based on alternate term information; and
inserting the alternate term into the modified job search query, and associating the alternate term and the specific term via an OR operator.

12. A system comprising:
a query module, implemented by one or more processors, configured to:
receive, via a user interface of a job search engine, a user specification of a job search query including at least one user-specified job search query term;
access, from a database associated with an online social networking service, values for one or more member profile attributes of the user; and
modify the job search query based on the accessed values for the member profile attributes of the user, the modifying comprising inserting job search query terms corresponding to the values for the member profile attributes into the job search query; and
a search module, implemented by the one or more processors, configured to:
generate search results corresponding to job listings posted on the job search engine, based on the modified job search query; and
cause one or more of the search results to be displayed, via the user interface.

13. The system of claim 12, wherein the one or more member profile attributes include job title, location, industry, skills, and seniority level.

14. The system of claim 12, wherein each of the job listings in the job search engine are associated with one or more job listing data fields, when the data fields include at least one of company, job title, location, industry, skills, and job description.

15. The system of claim 12, wherein the modifying further comprises inserting a search field limitation operator into the job search query in association with each of the inserted job search query terms, each of the search field limitation operators specifying that a particular job listing data field of plural job listings is to be searched for the corresponding inserted job search query term.

16. The system of claim 15, wherein each of the search field limitation operators specifies the particular job listing data field that is related to the member profile attribute associated with the corresponding inserted job search query term.

17. The system of claim 12, wherein the query module is further configured to determine that the user-specified job search query term corresponds to a value of a particular job listing data field of plural job listings, and
wherein the modifying further comprises inserting a search field limitation operator into the job search query in association with the user-specified job search query term, the search field limitation operator specifying that the particular job listing data field of the plural job listings is to be searched for the user-specified job search query term.

18. The system of claim 12, wherein the particular job listing data field corresponds to a company, a job title, a location, an industry, or a skill.

19. The system of claim 12, wherein the search module is further configured to:
determine, for each search result in the search results, a feature value indicating a number of job search query terms in the modified job search query that are detected in the corresponding search result;
rank the search results, based on the feature values associated with each of the search results; and
cause the ranked search results to be displayed to the user.

20. A non-transitory machine-readable storage medium comprising instructions that, when executed by one or more processors of a machine, cause the machine to perform operations comprising:
receiving, via a user interface of a job search engine, a user specification of a job search query including at least one user-specified job search query term;
accessing, from a database associated with an online social networking service, values for one or more member profile attributes of the user;
modifying the job search query based on the accessed values for the member profile attributes of the user, the modifying comprising inserting job search query terms corresponding to the values for the member profile attributes into the job search query;
generating search results corresponding to job listings posted on the job search engine, based on the modified job search query; and
causing one or more of the search results to be displayed, via the user interface.
